(19) United States
(12) Patent Application Publication
(10) Pub. No.: US 2003/0046047 A1
(43) Pub. Date: Mar. 6, 2003

(54) Integrated multi-disciplinary optimization process for thermal protection system design

(75) Inventors: Jian Dong, Irvine, CA (US); James Rowe, Villa Park, CA (US)

Correspondence Address: DiPINTO & SHIMOKAJI, P.C., Suite 480, 1301 Dove Street, Newport Beach, CA, 92660, US

(73) Assignee: The Boeing Company, Seattle, WA

(21) Appl. No.: 09/945,306

(22) Filed: Aug. 30, 2001

(51) Int. Cl. G06G 7/48

(52) U.S. Cl. 703/6

(57) ABSTRACT

A multi-disciplinary method for design optimization includes developing a number of single-disciplinary modules, which are integrated into a multi-disciplinary module, and performing system level optimization and sensitivity analyses using the multi-disciplinary module. Each single-disciplinary module includes simulation code which can be run on a computer and interfaced with at least one input file and one output file. Developing single-disciplinary modules includes constructing a reusable component for each single-disciplinary module. The reusable component wraps the simulation code by file parsing the simulation code input and output files. By wrapping the simulation codes, the single-disciplinary modules can be interfaced by placing the reusable components for each single-disciplinary module in communication with each other. The reusable component also formulates a problem by defining objectives, constraints and knowledge rules, as well as selects one or more optimization algorithms. System level optimization can be performed by concurrently performing single-discipline analyses using the communicating single-disciplinary modules.

### BACKGROUND OF THE INVENTION

The present invention generally relates to multi-disciplinary design systems and processes and, more particularly, to a multi-disciplinary design optimization system and process for designing thermal protection systems.

Thermal protection systems (TPS) provide thermal shields against very high temperatures during a space vehicle's reentry into the earth's atmosphere or a hypersonic vehicle as it flies in the atmosphere. TPS design is a complicated process drawing on several distinct disciplines including trajectory calculation, aerodynamics, thermal analysis, structural design, and manufacturing. High-speed flying vehicles, such as reusable space vehicles, space reentry vehicles, space planes, hypersonic vehicles and some types of missile systems, for example, can require a thermal protection system to shield the vehicle against very high temperature during flight. The design of a thermal protection system is a multi-disciplinary process that typically, as in the following example of a current process, incorporates decisions involving trajectory calculation, aerodynamics, aero-thermal analysis, vehicle structural design and analysis, TPS stress, manufacturing, and materials.

A sequential process is currently used in TPS design where decisions related to a TPS design are made unilaterally in each discipline. In current processes, a TPS design is conducted in multiple individual island operations. In other words, a portion of the total design is undertaken separately in each discipline, and the results from each separate design effort are passed on, in the form of various constraints and parameters, for example, to designers in the other disciplines. For example, a current process for TPS design can include the following primary steps:

1) trajectories are first calculated based on different mission requirements;

2) a vehicle configuration and structure is then determined based on aerodynamics load analysis;

3) aero-heating is calculated for selected vehicle body points, and TPS types, materials and thicknesses are determined based on the heating information;

4) a smooth aerodynamic profile is generated based on the individual body point tile thickness;

5) initial plan-form shape (horizontal size) is determined based on the profile;

6) manufacturability is assessed; and

7) stress/strength is evaluated for the plan-form shape decided upon.

A trial-and-error manual approach, also referred to as “design-evaluate-redesign”, is currently used for the individual island operations, and is schematically illustrated in FIG. 1A. A trial-and-error manual approach, or design-evaluate-redesign, is currently used as well for the entire multi-disciplinary process, and is schematically illustrated in FIG. 1B.

An example of a currently used single-disciplinary design process is illustrated in FIG. 1A by single-disciplinary design optimization process 100, which includes engineer 102, who provides inputs 104 to computer 106 running computer program 108 comprising simulation code, which provides outputs 110 back to engineer 102. Engineer 102, using his experience and knowledge, as well as other information at his disposal, evaluates outputs 110 in light of inputs 104, and then engineer 102 may either change inputs 104 and rerun the simulation code of computer program 108, or engineer 102 may decide that a satisfactory solution has been reached.

An example of a currently used multi-disciplinary design process is illustrated in FIG. 1B by multi-disciplinary design process 120, which includes chief engineer 122 and a number of single-disciplinary engineers 123. Each of the single-disciplinary engineers may perform a single-disciplinary design process, as shown in FIG. 1A. For example, there may be seven single-disciplinary engineers 123, with each one corresponding to one of the seven disciplines and the seven primary process steps referred to above.

Thus, each of the single-disciplinary engineers 123 may perform a single-disciplinary design process, as above, by providing inputs 124 to computers 126 running computer programs 128 comprising simulation code, which provides outputs 130 back to single-disciplinary engineers 123. Single-disciplinary engineers 123, using their experience and knowledge, as well as other information at their disposal, may evaluate outputs 130 in light of inputs 124, and then each of the single-disciplinary engineers 123 may either change inputs 124 and rerun the simulation code of computer program 128, or decide that a satisfactory solution has been reached.

Multi-disciplinary design process 120 is further complicated, however, by the fact that each of the single disciplines needs to communicate with the other single disciplines, as indicated by arrows 132 in FIG. 1B. Furthermore, each of the single-disciplinary engineers 123 must rely on certain individual inputs 134 provided by chief engineer 122 in modifying their own inputs 124. And, as well, each of the single-disciplinary engineers 123 must rely on certain global inputs 136 provided by chief engineer 122 in modifying their own inputs 124. The single-disciplinary engineers 123 provide global outputs 138 back to chief engineer 122.

Chief engineer 122, using his experience and knowledge, as well as other information at his disposal, evaluates global outputs 138 in light of global inputs 136 and individual inputs 134, and then chief engineer 122 may either change global inputs 136 or individual inputs 134, and have some or all of single-disciplinary engineers 123 rerun their simulation codes of computer programs 128, or chief engineer 122 may decide that a satisfactorily optimal cross-discipline or multi-disciplinary solution has been reached.

The sequential process currently used in TPS design, with decisions related to the TPS design made unilaterally in each discipline, entailing the use of a trial-and-error manual approach, or a design-evaluate-redesign manual approach, often results in frequent design changes, longer design cycle time, increased design cost, and difficulty in conducting system level sensitivity analysis to achieve optimal design solutions. The difficulty in communicating and passing information back and forth between and across disciplines makes it almost impossible to conduct a cross-discipline sensitivity analysis and trade-off study.

To reduce the number and extent of costly design changes, engineers in different disciplines are encouraged to have more communication with each other. Concurrent engineering and integrated product teams are some of the concepts that are widely promoted in industry today to increase communication among engineers. Many companies even physically co-locate engineers who are from different disciplines but work on the same project. These approaches, to some extent, do increase the level of communication among engineers. Due to the lack of systematical processes, however, and the lack of analytical methods and tools, as well as the nature of human beings to resist change, these approaches have had a limited success in improving the effectiveness of overall system design. Sometimes these approaches can even make the design cycle time longer.

As can be seen, there is a need for a systematic multidisciplinary design optimization process, which integrates a series of analytical methods and tools used by engineers in different disciplines. There is also a need for an integrated multidisciplinary optimization process that will make concurrent decision making across disciplines possible, providing multidisciplinary optimization, cross-discipline sensitivity analysis, and cross-discipline trade-off analysis. Moreover, there is a need for improvement in the design solutions and reduction in design cycle time in the manual design-evaluate-redesign processes used in the individual island operations of the several engineering disciplines, as well as in the system level engineering processes. Furthermore, there is a need for an innovative TPS design process that provides significant reduction in design cycle time, cost, and TPS weight.

### SUMMARY OF THE INVENTION

The present invention provides a systematic multi-disciplinary design optimization process, which integrates a series of analytical methods and tools used by engineers in different disciplines. In particular, the present invention provides an integrated multi-disciplinary design optimization process that makes concurrent decision making across disciplines possible, and provides multi-disciplinary optimization, cross-discipline sensitivity analysis, and cross-discipline trade-off analysis. Moreover, by automating the manual design-evaluate-redesign process, which makes it possible to quickly search a much larger design space, the present invention provides improved design solutions and reductions in design cycle time over the manual design-evaluate-redesign processes used in individual island operations of separate engineering disciplines, as well as in system level engineering processes. Furthermore, the invention provides an innovative TPS design process that provides significant reduction in design cycle time, cost, and TPS weight.

In one aspect of the present invention, a multi-disciplinary method for design optimization includes developing a number of single-disciplinary modules, which are integrated into a multi-disciplinary module, and performing system level optimization and system level sensitivity analyses using the multi-disciplinary module. Each of the single-disciplinary modules includes simulation code which can be run on a computer, and takes input from a simulation code input file, and writes output of the simulation to a simulation code output file. Development of the single-disciplinary modules includes constructing a reusable component for each of the single-disciplinary modules. The reusable component wraps the simulation code by file-parsing the simulation code input files and output files. By wrapping the simulation code of each single-disciplinary module, the single-disciplinary modules can be interfaced by placing the reusable components in communication with each other between single-disciplinary modules. System level optimization can then be performed by concurrently performing single-discipline analyses using the single-disciplinary modules, which are in communication with each other. For example, if the multi-disciplinary module includes single-disciplinary modules for trajectory analysis, thermal analysis, and TPS thickness analysis, a system level optimization, or cross-discipline analysis, can be performed which optimizes a TPS design relative to trajectory, thermal, and TPS thickness considerations simultaneously.

In another aspect of the present invention, a system for multi-disciplinary design optimization includes a number of single-disciplinary modules, each of which includes one or more simulation codes, simulation code input files in communication with the simulation codes, and simulation code output files in communication with the simulation code. Each single-disciplinary module also includes a reusable component in communication with the simulation codes through the simulation code input files and the simulation code output files.

The single-disciplinary modules are integrated into a multi-disciplinary module by providing interfaces between reusable components of the various single-disciplinary modules. The single-disciplinary modules communicate with each other through an interface between reusable components by passing information from one reusable component having a wrapped simulation code in one of the single disciplinary modules to another reusable component having a wrapped simulation code in another single-disciplinary module.

These and other features, aspects and advantages of the present invention will become better understood with reference to the following drawings, description and claims.

### BRIEF DESCRIPTION OF THE DRAWINGS

FIG. 1A is a schematic diagram of a current single-disciplinary process for design optimization;

FIG. 1B is a schematic diagram of a current multi-disciplinary process for design optimization;

FIG. 2A is a schematic diagram of an automated single-disciplinary process for design optimization according to one embodiment of the present invention;

FIG. 2B is a schematic diagram of an automated multi-disciplinary process for design optimization according to one embodiment of the present invention;

FIG. 3A is a schematic diagram of a single-disciplinary module for design optimization according to one embodiment of the present invention;

FIG. 3B is an example of problem definition using a reusable component according to an embodiment of the present invention;

FIG. 4 is a schematic diagram of a plurality of single-disciplinary modules for design optimization according to one embodiment of the invention;

FIG. 5 is a schematic diagram of a multi-disciplinary system and process for design optimization according to an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention provides a significant advance in large and complex system design processes. In current practice, the design of complex systems, such as TPS, are carried out manually, discipline by discipline. A design solution for a discipline is not obtained by searching a wide design space. Instead, it is often obtained when a deadline and/or budget limit is reached. Usually, only a few of the many design alternatives are evaluated. For a cross-discipline or multi-disciplinary design, to evaluate even a few design alternatives usually will take a lot of time. It becomes very difficult to conduct a cross-discipline or multi-disciplinary sensitivity analysis and trade off study. To attain a truly optimal solution becomes almost impossible.

The present invention, however, provides a systematic approach to overcoming these difficulties. It automates not only the individual single-disciplinary design processes but also the cross-discipline and multi-disciplinary design-evaluate-redesign process, which makes it much easier to conduct cross-discipline and multi-disciplinary sensitivity analyses and trade off studies. Furthermore, the present invention makes it possible to obtain an optimal solution both in single-discipline and multiple-discipline analyses.

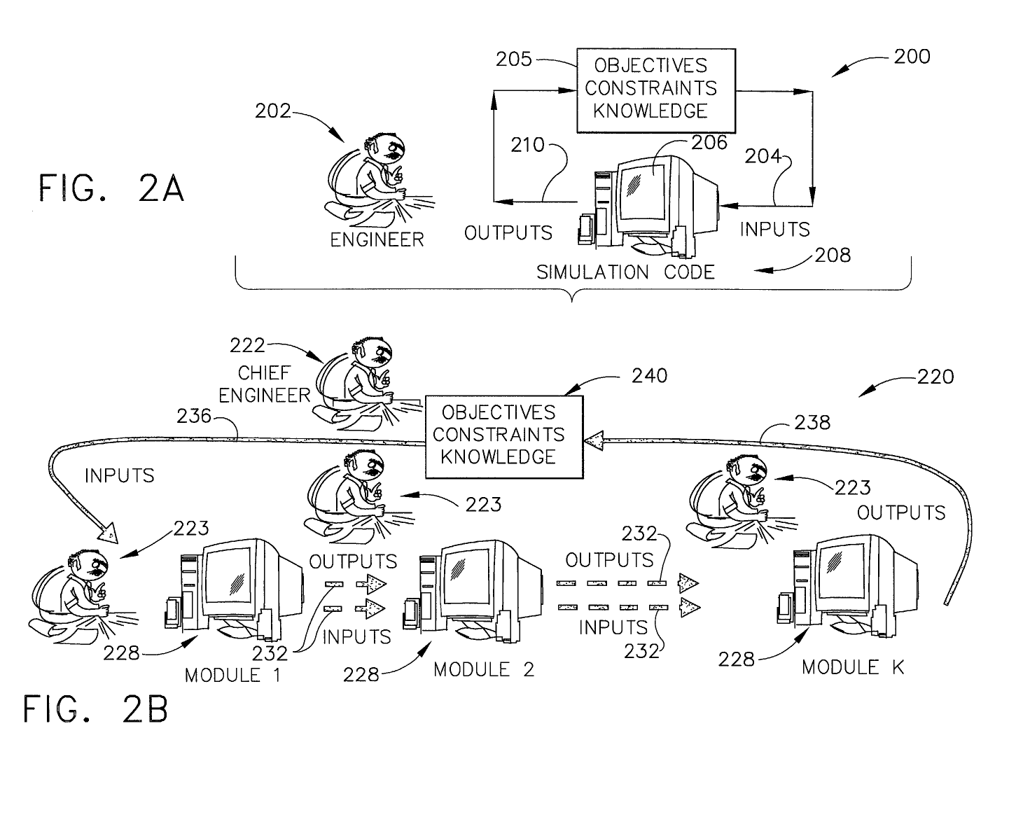

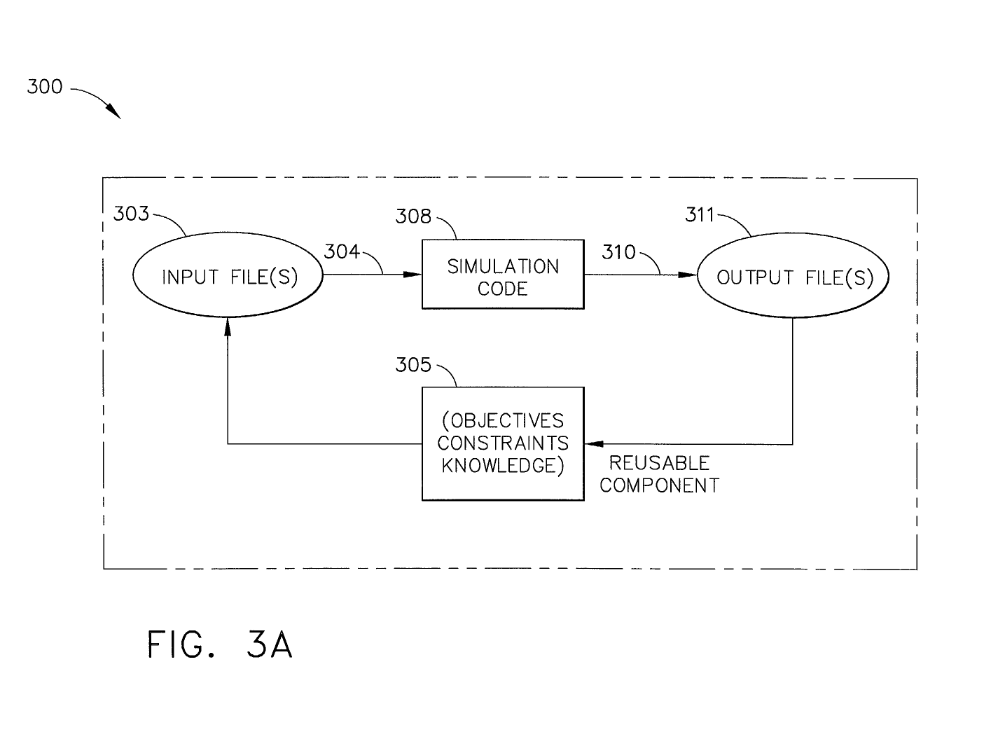

Referring now to FIGS. 2A and 2B, the integrated multi-disciplinary optimization design process can be conceptually built up from single-disciplinary optimization design processes. Single-disciplinary modules are first developed for use in the single-disciplinary optimization design processes and then a multi-disciplinary module is developed for use in the integrated multi-disciplinary optimization design process, also referred to as “system level” optimization and analysis.

An example of a single-disciplinary design process according to one embodiment is illustrated in FIG. 2A by single-disciplinary design optimization process 200, which includes engineer 202, who interfaces and interacts with reusable component 205 by, for example, providing problem definition in the form of objectives, constraints, and knowledge rules. The objectives, constraints, and knowledge rules can be specific to each separate discipline. Cross-disciplinary objectives, constraints, and knowledge rules can apply to more than one or all of the disciplines. Once the reusable component is constructed and problem definition formed, reusable component 205 provides inputs 204 to computer 206 running computer program 208 comprising simulation code, which provides outputs 210 back to reusable component 205.

Based on the problem definition, and the particular simulation code, the loop comprising reusable component 205 providing inputs 204 to computer 206 running computer program 208 executing the simulation code and providing outputs 210 back to reusable component 205 may be repeated, generating multiple design solutions quickly and finding a satisfactorily optimal solution. The problem definition may embody any of several or a combination of optimization techniques as known in the art. For example, various search algorithms for non-linear constrained optimization may be used, such as exploratory methods including simulated annealing, and genetic algorithms; numerical methods including modified method of feasible solutions, sequential linear/quadratic programming, and penalty methods; and knowledge based methods including heuristic search/rule-based systems.

During the execution of single-disciplinary design optimization process 200, engineer 202 continues to interact with reusable component 205. Engineer 202, using his experience and knowledge, as well as other information at his disposal, may, for example, evaluate the design solutions reached and further modify the simulation techniques or refine the problem definition, and then re-execute the entire process, or engineer 202 may decide that a satisfactorily optimal solution has been reached.

An example of multi-disciplinary design process according to one embodiment is illustrated in FIG. 2B by multi-disciplinary design optimization process 220, which includes chief engineer 222 and a number of single-disciplinary engineers 223. Each of the single-disciplinary engineers may be responsible for a single-disciplinary design optimization process, as shown in FIG. 2A, for example, by providing appropriate simulation technique, simulation code, and problem definition for a reusable component.

Multi-disciplinary design optimization process 220 has been integrated and automated, so that each of the single-disciplinary modules 228 communicates with the other single-disciplinary modules 228, as indicated by input and output arrows 232 in FIG. 2B. Global inputs 236 are provided from reusable component 240 to multi-disciplinary design optimization process 220 and global outputs 238 are received from multi-disciplinary design optimization process 220 by reusable component 240 based on the reusable component construction and problem definition formation by chief engineer 222, as well as interaction of chief engineer 222 with reusable component 240 during execution of multi-disciplinary design optimization process 220.

In a similar manner as described above in connection with single-disciplinary design optimization process 200, during the execution of multi-disciplinary design optimization process 220, chief engineer 222 continues to interact with reusable component 240 as well as with single-disciplinary engineers 223. Chief engineer 222, using his experience and knowledge, as well as other information at his disposal may, for example, evaluate the design solutions reached and further modify the simulation techniques or refine the problem definition, and then re-execute the entire process, or chief engineer 222 may decide that a satisfactorily optimal solution has been reached.

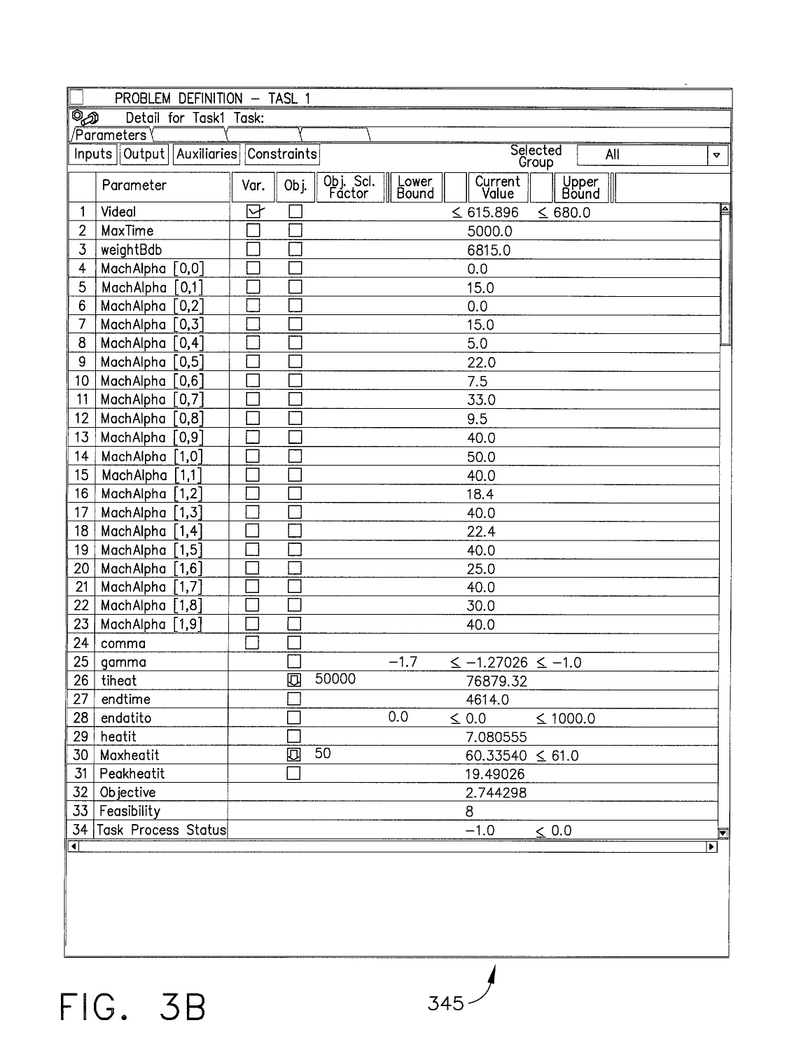

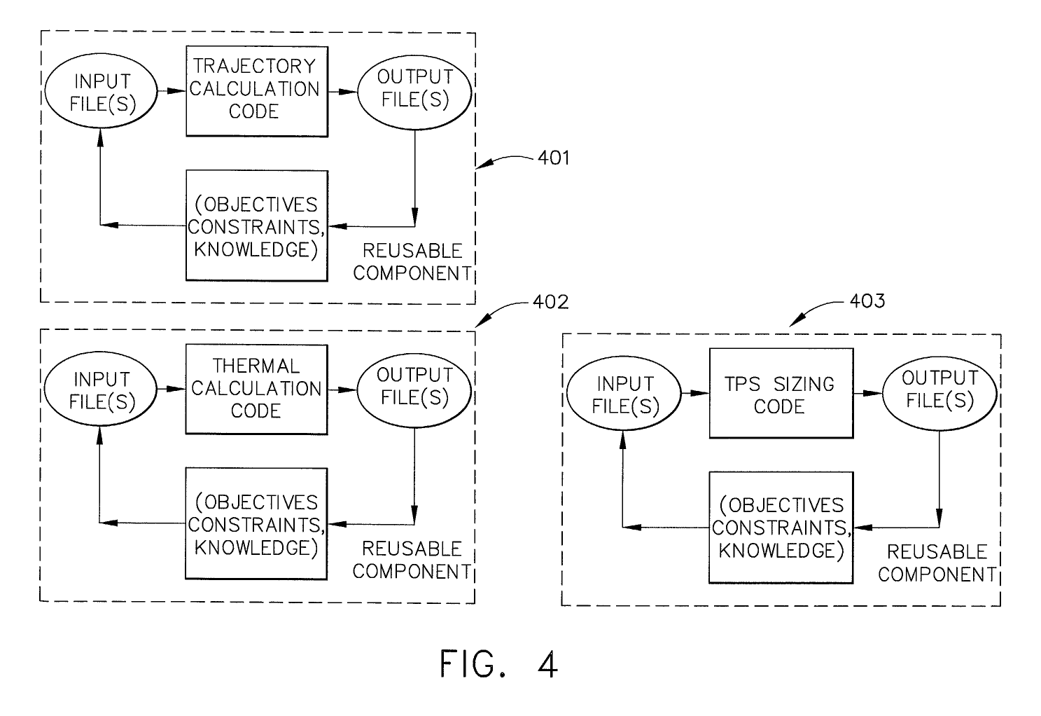

FIG. 3A shows single-disciplinary module 300 for design optimization in accordance with one embodiment. Single-disciplinary module 300 includes simulation code 308, which may be executed by a computer program running on a computer (not shown in FIG. 3A). Simulation code 308 receives input 304 from simulation code input file 303 and writes output 310 to simulation code output file 311. Single-disciplinary module 300 includes reusable component 305 in communication with simulation code input file 303 and with simulation code output file 311.

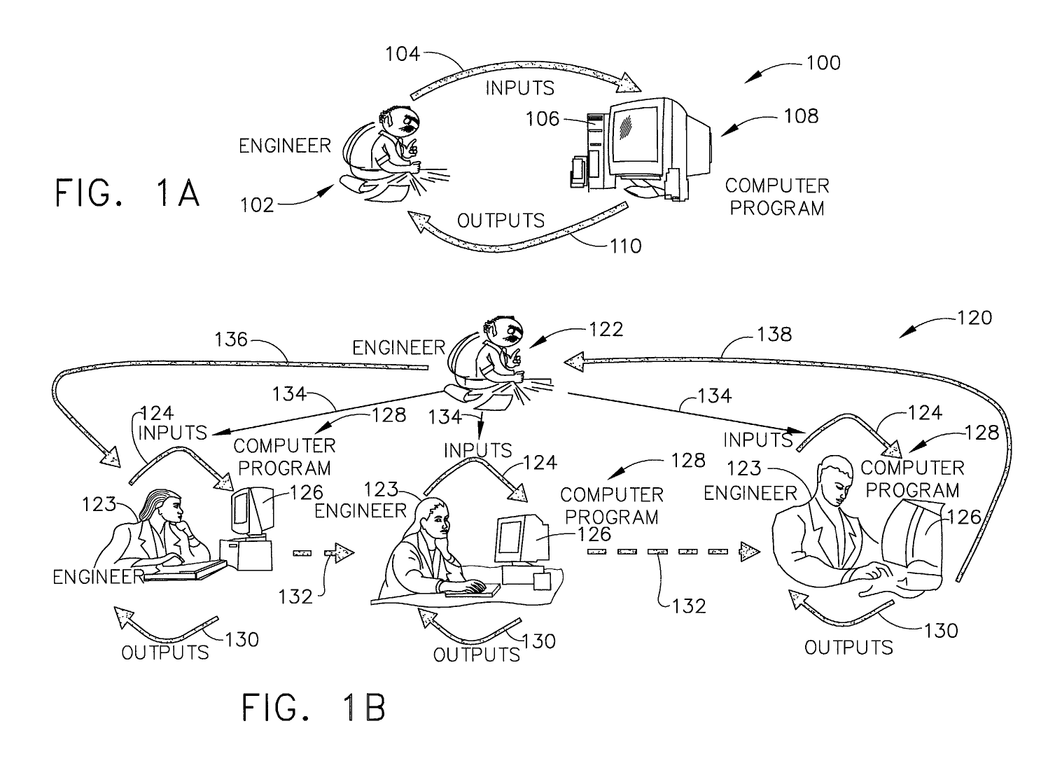

A modular based black box approach is used to develop single-disciplinary module 300 for automating the design-evaluate-redesign process in each discipline. Each single-disciplinary module 300 includes one or more simulation codes 308 that are used to evaluate the design requirements for the discipline. Without changing simulation codes, each module is built by wrapping one or more simulation codes 308 into reusable component 305 through parsing simulation code input and output files 303 and 311. File parsing is a mechanism that reads selected data from an output file, generates a set of data based on the input parameters predefined, and writes the set of data into an input file. The set of data is generated based on an optimization model predefined and an optimization algorithm selected. The data flow in each single-disciplinary module 300 is controlled by the file parsing mechanism. Each single-disciplinary module 300 automates a single discipline design cycle and can be used to generate multiple design solutions. An optimization scheme built into each single-disciplinary module 300 provides the capability to conduct optimization and sensitivity analysis inside the discipline. For example, every single-disciplinary design optimization process in FIG. 1B, i.e. each of the seven processes described in connection with FIGS. 1A and 1B, can be built into a module.

FIG. 3B illustrates an example of problem definition using reusable component 305 according to an embodiment of the present invention. FIG. 3B shows problem definition screen 345 as used for forming problem definition in reusable component 305 according to one embodiment. Problem definition screen 345 allows formulation of a problem, for example, by allowing definition of objectives, constraints, and knowledge rules. For example, an objective can be to minimize a certain variable or parameter, such as tile thickness. Also, for example, a constraint can be that a certain variable or parameter remain within a certain range, and a knowledge rule can relate the behavior of certain interdependent variables or parameters. Problem definition screen 345 can be provided by a commercial software program, such as iSIGHT® by Engineous Software, Inc., see “iSIGHT Designer's Guide”, Engineous Software, Inc., 1998.

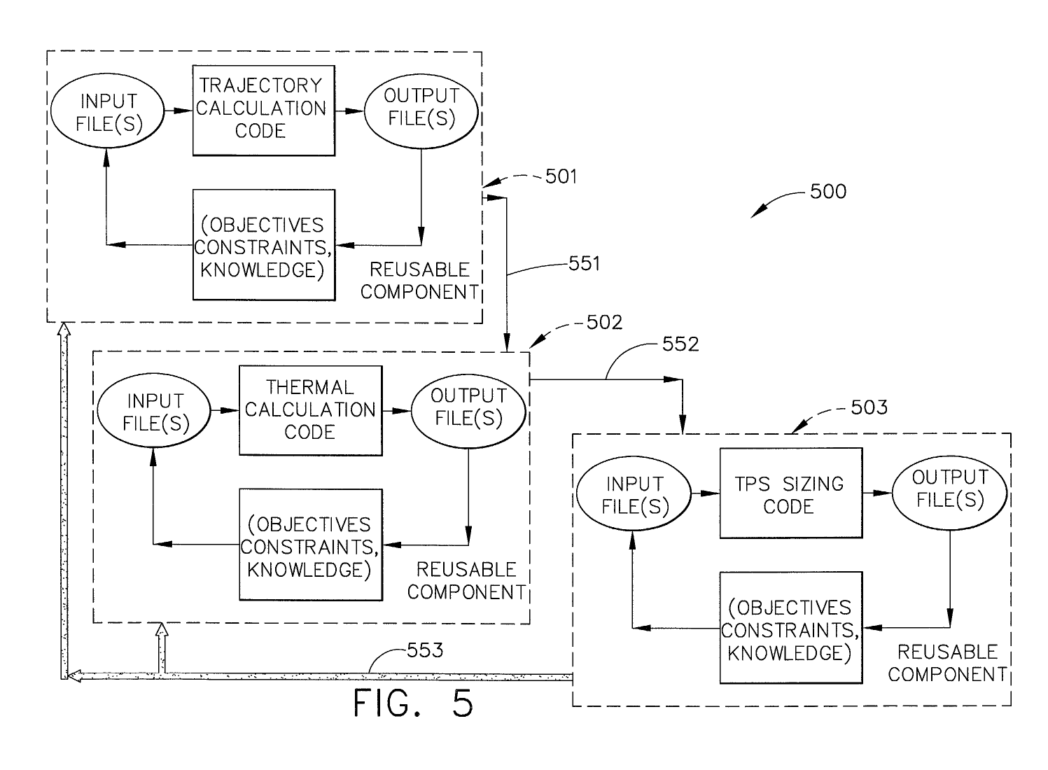

FIG. 4 illustrates three single-disciplinary modules for design optimization according to one embodiment of the invention for three separate disciplines. Each of single-disciplinary modules 401, 402, and 403 is developed as described above for single-disciplinary module 300. As seen in FIG. 4, single-disciplinary module 401 can be developed for the discipline of trajectory calculation, corresponding to one of the seven processes described in connection with FIGS. 1A and 1B. Also as seen in FIG. 4, single-disciplinary module 402 can be developed for the discipline of thermal calculation, and single-disciplinary module 403 can be developed for the discipline of TPS sizing, also corresponding to one of the seven processes described in connection with FIGS. 1A and 1B. As noted above, each of the seven processes described in connection with FIGS. 1A and 1B, can be developed into a single-disciplinary module.

FIG. 5 illustrates, in schematic diagram form, a multi-disciplinary system for design optimization according to an embodiment of the present invention. FIG. 5 shows multi-disciplinary module 500 comprising single-disciplinary modules 501, 502, and 503, corresponding to single-disciplinary modules 401, 402, and 403 of FIG. 4, which provide automated single-disciplinary design optimization processes for the disciplines of trajectory calculation, thermal calculation, and TPS sizing, respectively. Single-disciplinary modules 501, 502, and 503 are integrated into multi-disciplinary module 500 by providing interfaces 551, 552, and 553 between reusable components of each of single-disciplinary modules 501, 502, and 503. Thus, each of single-disciplinary modules 501, 502, and 503 is in communication with each of the other single-disciplinary modules 501, 502, and 503. Communication between modules is facilitated by the use of reusable components to wrap each simulation code using file parsing, as described above. Each reusable component, for example, may be implemented in iSIGHT® to facilitate communication between the reusable components. Using multi-disciplinary module 500, system level optimization can be performed as described above in connection with FIG. 2B, as well as multi-disciplinary and cross-discipline sensitivity analyses and trade-off studies.

The present invention provides a systematic multi-disciplinary design optimization process, which automates and integrates several single-disciplinary design optimization processes. By automating the manual design-evaluate-redesign process, which makes it possible to quickly search a much larger design space, the present invention provides improved design solutions and reductions in design cycle time over the manual design-evaluate-redesign processes used in individual island operations of separate engineering disciplines, as well as in system level engineering processes. In one embodiment, the present invention can achieve a significant reduction over prior art in the design cycle time, cost, and weight of a TPS. In another embodiment, in which a single-disciplinary design process for Boeing's Delta IV Tail Mast Service System design was implemented, a substantial savings in material costs was achieved. In another embodiment, the process for designing a Shuttle jet profile for docking the Space Shuttle to a Space Station was tested and significantly reduced both design cycle time and fuel consumption.

It should be understood, of course, that the foregoing relates to preferred embodiments of the invention and that modifications may be made without departing from the spirit and scope of the invention as set forth in the following claims.

We claim:

1. A method for design optimization comprising steps of:
developing a plurality of single-disciplinary modules;
integrating said plurality of single-disciplinary modules into a multi-disciplinary module; and
performing system level optimization using said multi-disciplinary module.

2. The method of claim 1 further comprising a step of performing system level sensitivity analysis using said multi-disciplinary module.

3. The method of claim 1 wherein said step of developing said plurality of single-disciplinary modules comprises providing at least one simulation code, at least one simulation code input file, and at least one simulation code output file.

4. The method of claim 3 wherein said step of developing said plurality of single-disciplinary modules comprises constructing a reusable component for each of said plurality of single-disciplinary modules, wherein said reusable component wraps said at least one simulation code by file parsing said at least one simulation code input file and said at least one simulation code output file.

5. The method of claim 4 wherein said integrating step comprises interfacing said plurality of single-disciplinary modules wherein said reusable component of one of said plurality of single-disciplinary modules communicates with said reusable component of another of said plurality of single-disciplinary modules.

6. The method of claim 5, wherein said integrating step comprises interfacing each of said plurality of single-disciplinary modules with at least one other of said plurality of single-disciplinary modules.

7. The method of claim 1, wherein said step of performing system level optimization comprises concurrently performing single-discipline analyses using said plurality of single-disciplinary modules.

8. The method of claim 7, wherein said step of performing single-discipline analyses includes performing a trajectory analysis.

9. The method of claim 7, wherein said step of performing single-discipline analyses includes performing a thermal analysis.

10. The method of claim 7, wherein said step of performing single-discipline analyses includes performing a TPS thickness analysis.

11. A method for design optimization comprising steps of:
providing at least one simulation code;
placing a simulation code input file in communication with said at least one simulation code;
placing a simulation code output file in communication with said at least one simulation code;
automating evaluation of outputs from said simulation code output file and selection of inputs to said simulation code input file; and
performing a single-discipline optimization using said inputs and outputs.

12. The method of claim 11 further comprising a step of performing single-discipline sensitivity analysis using said inputs and outputs.

13. The method of claim 11 wherein said step of automating comprises constructing a reusable component, wherein said reusable component wraps said at least one simulation code by file parsing said simulation code input file and said simulation code output file.

14. The method of claim 11, wherein said step of performing single-discipline optimization includes performing a trajectory analysis.

15. The method of claim 11, wherein said step of performing single-discipline optimization includes performing a thermal analysis.

16. The method of claim 11, wherein said step of performing single-discipline optimization includes performing a TPS thickness analysis.

17. A system for design optimization comprising:
a plurality of single-disciplinary modules, each of said plurality of single-disciplinary modules having a simulation code; and
a multi-disciplinary module including said plurality of single-disciplinary modules wherein at least one of said plurality of single-disciplinary modules has an interface between reusable components, said interface between reusable components communicating with another of said plurality of single-disciplinary modules, whereby said plurality of single-disciplinary modules is integrated into said multi-disciplinary module.

18. The system of claim 17, wherein each of said plurality of single-disciplinary modules has a simulation code input file in communication with said simulation code and a simulation code output file in communication with said simulation code.

19. The system of claim 17, wherein each of said plurality of single-disciplinary modules has a reusable component in communication with said simulation code input file and in communication with said simulation code output file.

20. The system of claim 19, wherein each of said reusable components communicates with said simulation code input file and said simulation code output file by file parsing said simulation code input file and said simulation code output file, whereby said simulation code is wrapped by said reusable component.

21. The system of claim 20, wherein said at least one of said plurality of single-disciplinary modules communicates with said other of said plurality of single-disciplinary modules through said interface between reusable components by passing information from a first reusable component having a first wrapped simulation code of said at least one of said plurality of single-disciplinary modules to a second reusable component having a second wrapped simulation code of said other of said plurality of single-disciplinary modules.

22. The system of claim 21, wherein each of said plurality of single-disciplinary modules communicates with at least one other of said plurality of single-disciplinary modules through said interface between reusable components by passing said information.

23. The system of claim 17, wherein said plurality of single-disciplinary modules includes a trajectory analysis module.

24. The system of claim 17, wherein said plurality of single-disciplinary modules includes a thermal analysis module.

25. The system of claim 17, wherein said plurality of single-disciplinary modules includes a TPS thickness analysis module.

26. A system for design optimization comprising:
a plurality of single-disciplinary modules, each of said plurality of single-disciplinary modules having a simulation code, a simulation code input file in communication with said simulation code, a simulation code output file in communication with said simulation code, and each of said plurality of single-disciplinary modules having a reusable component in communication with said simulation code input file and in communication with said simulation code output file;
a multi-disciplinary module including said plurality of single-disciplinary modules wherein at least one of said plurality of single-disciplinary modules has an interface between reusable components to another of said plurality of single-disciplinary modules, wherein said at least one of said plurality of single-disciplinary modules communicates with said other of said plurality of single-disciplinary modules through said interface between reusable components by passing information from a first reusable component having a first wrapped simulation code of said at least one of said plurality of single-disciplinary modules to a second reusable component having a second wrapped simulation code of said other of said plurality of single-disciplinary modules, whereby said plurality of single-disciplinary modules is integrated into said multi-disciplinary module.
